(19) United States
(12) Patent Application Publication
(10) Pub. No.: US 2013/0067283 A1
(43) Pub. Date: Mar. 14, 2013

(54) METHOD AND APPARATUS FOR DETECTING FAILURES AND REQUESTING FAILURE DIAGNOSES

(71) Applicants: Jihyun LEE, Daejeon (KR); Ji Yeon SON, Daejeon (KR); Jeu Young KIM, Daejeon (KR); Jun Hee PARK, Daejeon (KR); Kyeong Deok MOON, Daejeon (KR)

(72) Inventors: Jihyun LEE, Daejeon (KR); Ji Yeon SON, Daejeon (KR); Jeu Young KIM, Daejeon (KR); Jun Hee PARK, Daejeon (KR); Kyeong Deok MOON, Daejeon (KR)

(73) Assignee: Electronics and Telecommunications Research Institute, Daejeon (KR)

(21) Appl. No.: 13/570,718

(22) Filed: Aug. 9, 2012

(30) Foreign Application Priority Data
Sep. 14, 2011 (KR) 10-2011-0092552

(51) Int. Cl. G06F 11/07

(52) U.S. Cl. 714/37; 714/E11.029

(57) ABSTRACT

A method for detecting failures and requesting failure diagnoses, includes receiving monitoring information from an resource object. Further, the method includes, if an error message is included in the received monitoring information, determining that a failure has been detected in the resource object to send a failure diagnosis request message to a failure diagnosis framework. Furthermore, the method includes receiving failure diagnosis result information from the failure diagnosis framework.

### CROSS-REFERENCE TO RELATED APPLICATION(S)

The present invention claims priority of Korean Patent Application No. 10-2011-0092552, filed on Sep. 14, 2011, which is incorporated herein by reference.

### FIELD OF THE INVENTION

The present invention relates to the diagnoses of failures occurring in a home/building network environment and; more particularly to a method and apparatus for detecting failures and requesting failure diagnoses, which are capable of automatically requesting a failure diagnosis failure when a home/building integrated resource manager receives an error message from a resource object on a home/building network and then detecting a failure, while allowing a user to enter failure detection information and then requesting a failure diagnosis using a user interface (UI) when there is no error message and the user has discovered a failure.

### BACKGROUND OF THE INVENTION

In general, conventional methods of diagnosing and handling the failures of a variety of electronic devices or network equipment in a home or a building mainly employ a technique in which a user detects the cause of the failures by analyzing a system log or failure occurrence messages.

That is, the conventional methods are burdensome in that a needs to detect all failures and request failure diagnoses to determine the causes of the failures, and are problematic in that the detection of the failures and requests for the diagnoses of the failures are delayed and also it is difficult to detect all the failures and request the diagnoses of all the failures.

### SUMMARY OF THE INVENTION

In view of the above, the present invention provides a method and apparatus for detecting failures and requesting failure diagnoses, which are capable of rapidly and automatically detecting a variety of failures in a home/building network environment and requesting failure diagnoses.

Further, the present invention provides a method and apparatus for detecting failures and requesting failure diagnoses, which are capable of automatically requesting a failure diagnosis when a home/building integrated resource manager receives an error message from a resource object on a home/building network to detect a failure, while allowing a user to enter failure detection information and then requesting a failure diagnosis using a user interface (UI) when there is no error message and the user has discovered a failure.

In accordance with a first aspect of the present invention, there is provided a method for detecting failures and requesting failure diagnoses, including: receiving monitoring information from an resource object; if an error message is included in the received monitoring information, determining that a failure has been detected in the resource object to send a failure diagnosis request message to a failure diagnosis framework; and receiving failure diagnosis result information from the failure diagnosis framework.

In accordance with a second aspect of the present invention, there is provided a method for detecting failures and requesting failure diagnoses including, if an error message is included in monitoring information received from an integrated resource manager, determining that a failure has been detected in a resource object to send a failure diagnosis request message to a failure diagnosis framework; making a failure diagnosis based on the error message at the failure diagnosis framework, to send failure diagnosis result information to the integrated resource manager; sending the failure diagnosis result information to a failure diagnosis user interface at the integrated resource manager; and outputting the failure diagnosis result information at the failure diagnosis user interface.

In accordance with a third aspect of the present invention, there is provided an apparatus for detecting failures and requesting failure diagnoses, including a resource object configured to, if a failure has occurred, second monitoring information including an error message; and an integrated resource manager configured to, if an error message is included in monitoring information received from the resource object, determine that a failure has occurred in the resource object, send a failure diagnosis request message to a failure diagnosis framework, and receive failure diagnosis result information from the failure diagnosis framework.

In accordance with a fourth aspect of the present invention, there is provided an apparatus for detecting failures and requesting failure diagnoses, including: an integrated resource manager configured to, if an error message is included in received monitoring information, determine that a failure has been detected in a resource object, and send a failure diagnosis request message to a failure diagnosis framework; a failure diagnosis framework configured to make a failure diagnosis based on the error message, and send failure diagnosis result information to the integrated resource manager; and a failure diagnosis user interface (UI) configured to, when receiving failure detection information of the resource object, send the failure detection information to the integrated resource manager, and, when receiving the failure diagnosis result information from the integrated resource manager, output the failure diagnosis result information. The method and apparatus for detecting the failures and requesting the failure diagnoses in accordance with the embodiments of the present invention have one or more of the following advantages.

In accordance with the present invention, it is possible to allow a user to detect the failure and request the failure diagnosis and also enable the failure to be automatically detected when the error message is sent by an object in which the failure occurred and the failure diagnosis to be requested based on the detection, thereby enabling all the failures to be covered and also reducing the delay time it takes to detect the failure and request the failure diagnosis.

That is, the home/building integrated resource manager may detect the failure and automatically request the failure diagnosis and a user may detect the failure and request the failure diagnosis based on the detection, so that rapid failure detection and rapid diagnosis request may be achieved and also all failures occurring in a home/building can be discovered and can be requested to be diagnosed.

### BRIEF DESCRIPTION OF THE DRAWINGS

The objects and features of the present invention will become apparent from the following description of preferred embodiments given in conjunction with the accompanying drawings, in which:

FIG. 1 is a diagram of an apparatus for detecting failures and requesting failure diagnoses in accordance with an embodiment of the present invention, which is capable of detecting a variety of failures occurring in a home/building network environment and requesting failure diagnoses;

FIG. 2 is a flow diagram showing a procedure by which a user detects a failure and automatically requests a failure diagnosis in accordance with the embodiment of the present invention;

FIG. 3 is a flow diagram showing a procedure by which the home/building integrated resource manager detects a failure and automatically requests a failure diagnosis in accordance with the embodiment of the present invention;

FIG. 4 is a flow chart showing an operation of the apparatus for detecting failures and requesting failure diagnoses in accordance with the embodiment of the present invention; and

FIG. 5 is a diagram showing failure occurrence information in accordance with the embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram.

Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

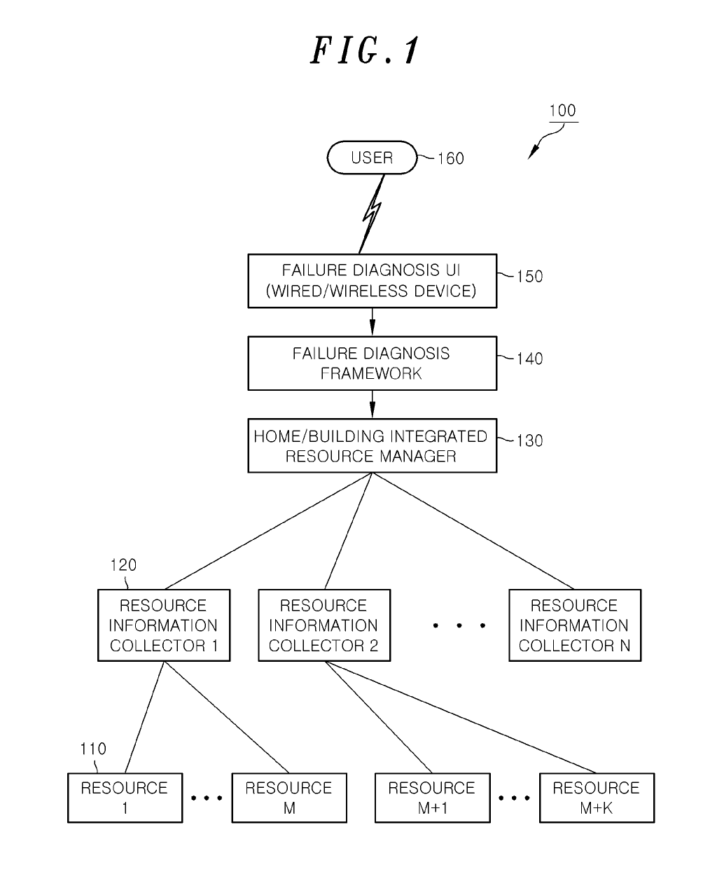

FIG. 1 is a diagram of an apparatus 100 for detecting failures and requesting failure diagnoses in accordance with an embodiment of the present invention, which is capable of detecting a variety of failures occurring in a home/building network environment and requesting the failure diagnoses.

Referring to FIG. 1, the apparatus 100 for detecting the failures and requesting the failure diagnoses may include a plurality of resources 1 to M, and M+1 to M+K 110, one or more resource information collectors 1 to N 120, a home/building integrated resource manager 130, a failure diagnosis framework 140, and a failure diagnosis UI (user interface) 150.

More specifically, the resource information collector 120 receives information about the monitoring of the resources 110 via a wired/wireless connection. Here, the collected resource information may include information about a resource object, such as a device, a network or a service, which may be managed inside a home/building.

The plurality of resources 110 may send monitoring information in real-time or periodically to the resource information collectors 120. Here, the monitoring information may include monitoring time, an equipment name, error occurrence time, information about whether an error has occurred, and an error code. That is, the resources 110 may periodically create monitoring information, or, when a failure occurs, may create monitoring information including an error message, such as the error occurrence time or the error code, and send the monitoring information to the resource information collectors 120.

Accordingly, the resource information collector 120 may send the collected information of the resources 110 to the home/building integrated resource manager 130 as soon as it receives the collected information of the resources 110, or may send the collected information of the resources 110 to the home/building integrated resource manager 130 after the information of the resources 110 has been collected for a preset time span or a preset number of pieces of monitoring information (error messages) has been collected.

Meanwhile, specific resources among the resources 110 may directly send the created monitoring information to the home/building integrated resource managers 130 without the intervention of the resource information collectors 120.

The home/building integrated resource manager 130 is connected to the resource information collectors 120 for collecting information from the resources 110 including a plurality of devices, a network or a service, and is connected to the failure diagnosis framework 140.

Furthermore, the home/building integrated resource manager 130 first receives a failure resource, that is, the error message which occurs in a resource object to detect a failure. In order to diagnose the failure, the home/building integrated resource manager 130 which has detected the failure may send the received error message indicative of the failure to the failure diagnosis framework 140 to request a failure diagnosis.

The failure diagnosis framework 140 is connected to the failure diagnosis UI 150, and performs the function of determining the cause of the failure when the home/building integrated resource manager 130 or a user requests that a failure in a home/building be diagnosed via the failure diagnosis user interface (UI) 150 of a wired/wireless device.

The function of determining the cause of the failure may be carried out by comparing an error code included in the error message with a database including preset error codes and descriptions of the respective error codes.

The apparatus 100 for detecting the failures and requesting the failure diagnoses may detect the failure via the home/building integrated resource manager 130 and automatically request the failure diagnosis from the failure diagnosis framework 140, and may also diagnose the cause of the failure based on information about a failure discovered by a user 160 and then provide the diagnosed results to the user 160.

More specifically, when the user 160 detects the failure, the user 160 may enter information of the detected failure via the failure diagnosis UI 150, and enters a diagnosis request command into the failure diagnosis framework 140. Furthermore, when the user 160 has a user terminal device connected to the failure diagnosis UI 150 via a wired/wireless connection, the user 160 may enter the information of the detected failure using the user terminal device, instead of directly entering same. Here, the user terminal device may include a variety of terminal devices, such as a mobile communication terminal, a smart phone, a notepad, and a tablet computer.

Accordingly, the failure diagnosis framework 140 may receive the failure diagnosis request message from the failure diagnosis UI 150, and diagnose the cause of the failure based on the error code included in the failure diagnosis request message. However, when an error keyword or phrase other than the error code has been entered in the failure diagnosis request message, the database may output a preset number of corresponding results including a matching error keyword or word (an identical keyword or word, a similar keyword or word, or the like).

Further, the function blocks of the apparatus 100 for detecting the failures and requesting the failure diagnoses may be connected to each other via a wired/wireless connection, and exchange information or data with each other. The communication method which may be used for the exchange may be at least one of mobile communication technologies such as CDMA (code division multiple access), WCDMA (wideband code division multiple access) and LTE (long term evolution), and wireless communication technologies such as Bluetooth, Wibro and WiFi.

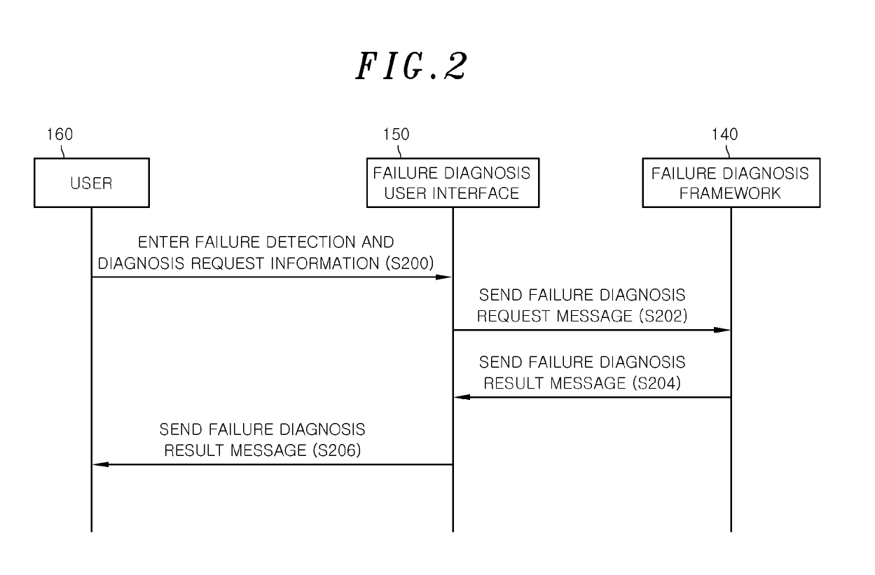

FIG. 2 is a flow diagram showing a procedure by which a user detects a failure and automatically requests a failure diagnosis in accordance with the embodiment of the present invention.

Referring to FIG. 2, when the user 160 detects the failure in at least one resource object, the user 160 enters information about whether the failure has been detected and diagnosis request information via the failure diagnosis UI 150 in step 200. In this case, the user 160 enters failure detection information, including failure equipment, error occurrence time, and an error code or an error description keyword and phrase, and a diagnosis request command.

Accordingly, the failure diagnosis UI 150 sends a failure diagnosis request message to the failure diagnosis framework 140 based on the failure detection information entered by the user in step 202. The failure diagnosis framework 140 diagnoses the cause of the failure based on the error code or the error description phrase included in the failure diagnosis message, and outputs the results of the diagnosis.

Thereafter, the failure diagnosis framework 140 includes information about the output results of the diagnosis in the failure diagnosis result message and sends the failure diagnosis result message to the failure diagnosis UI 150 in step S204. Accordingly, the failure diagnosis UI 150 outputs failure diagnosis result information onto a display unit so that the user 160 may view the failure diagnosis result information in step S206. Alternatively, the failure diagnosis UI 150 sends the failure diagnosis result information to the user terminal device of the user 160, so that the user 160 may check the received failure diagnosis result information at the user terminal device, thereby checking whether the failure has occurred in a corresponding resource.

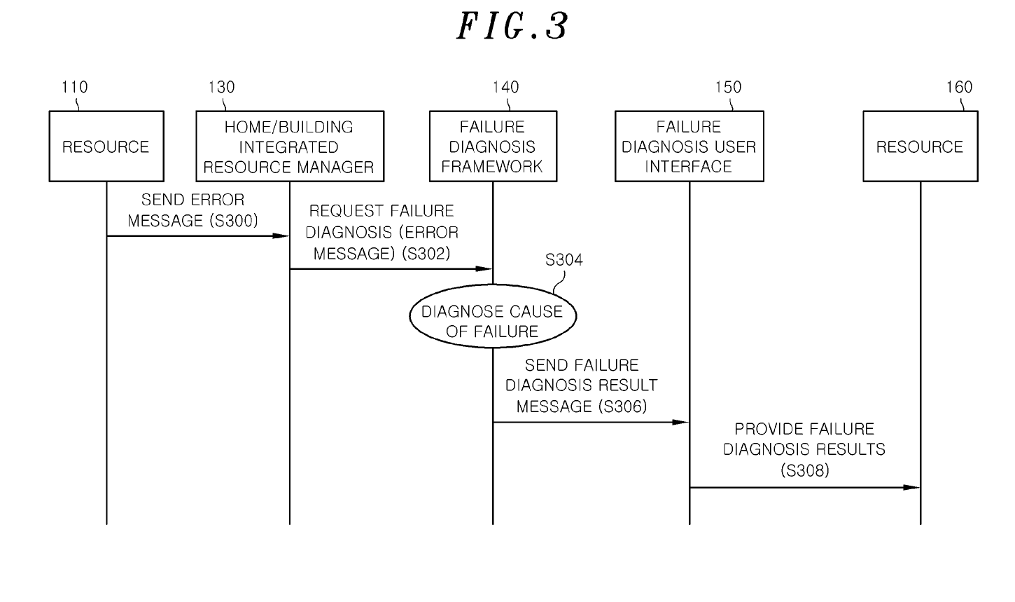

FIG. 3 is a flow diagram showing a procedure by which the home/building integrated resource manager detects a failure and automatically requests a failure diagnosis in accordance with the embodiment of the present invention.

Referring to FIG. 3, when the failure occurs in at least one resource 110 of the plurality of resources in a home/building, the corresponding resource 110 may send an error message to the home/building integrated resource manager 130 in step S300.

When the home/building integrated resource manager 130 receives the error message, the home/building integrated resource manager 130 may determine that the error or the failure has occurred in the resource 110 which has sent the error message, and send the failure diagnosis request message including the error message to the failure diagnosis framework 140 in step S302.

Accordingly, the failure diagnosis framework 140 may diagnose the cause of the failure in step S304. In detail, the failure diagnosis framework 140 may extract the error code from the error message included in the failure diagnosis request message, compare the extracted error code with a preset error code database, and then output database information matching the error code as the results of the failure diagnosis. Thereafter, the output failure diagnosis result information is included in the failure diagnosis result message and sent to the failure diagnosis UI 150 in step 306.

Thereafter, the failure diagnosis UI 150 may provide the results of the failure diagnosis included in the received failure diagnosis result message to the user 160 in step S308. That is, information about the results of the failure diagnosis is output onto a display unit included in the failure diagnosis UI 150, or is sent to the user terminal device of the user 160.

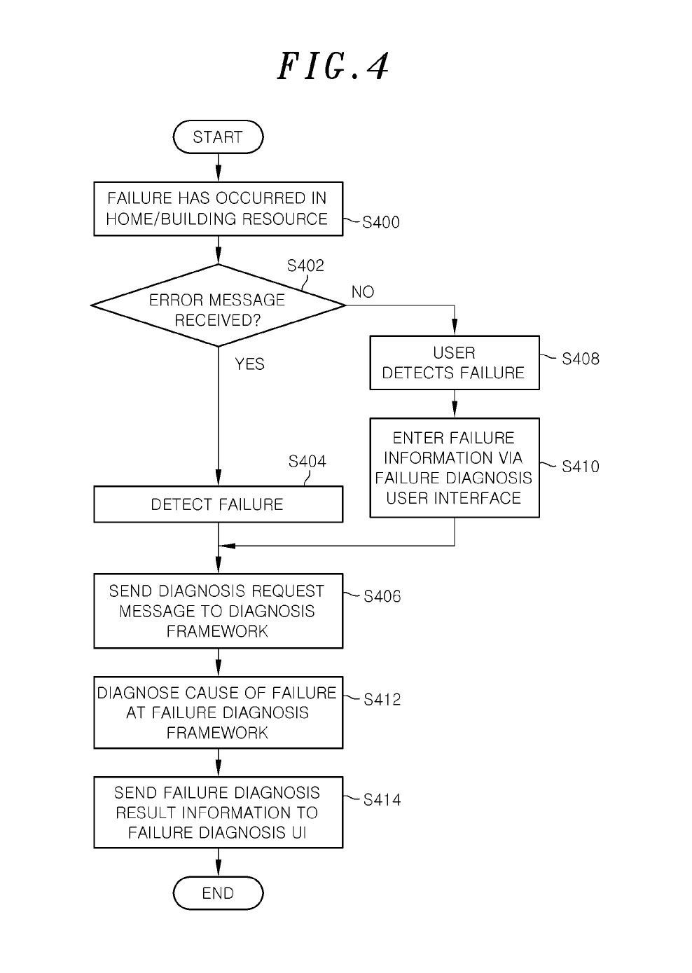

FIG. 4 is a flow chart showing an operation of the apparatus for detecting failures and requesting failure diagnoses in accordance with the embodiment of the present invention.

Referring to FIG. 4, when the failure occurs in the resource in a home/building network environment, the failure is detected, and a corresponding failure diagnosis is made. Specifically, when a failure has occurred in at least one resource 110, the resource 110 in which the failure has occurred may create the error message and transfer the created error message to the resource information collector 120, or may send the error message directly to the home/building integrated resource manager 130.

Here, when the resource information collector 120 receives the corresponding error message, e.g., when the error messages have been collected for a preset time span or a preset number of error messages have been collected, the collected error messages may be sent to the home/building integrated resource manager 130. Accordingly, when the home/building integrated resource manager 130 receives the error message in step S402, the home/building integrated resource manager 130 may determine that the failure has occurred in the corresponding resource 110, create the failure diagnosis request message based on the received error message, and automatically sends the failure diagnosis request message to the failure diagnosis framework 140 in step S406.

On the other hand, when the home/building integrated resource manager 130 receives no error message in step S402, e.g., when the home/building integrated resource manager 130 receives periodically sent monitoring information other than information about the occurrence of the failure in the resource 110, the process is terminated. However, when the user 160 detects the failure in another resource in step S408 and enters failure detection information via the failure diagnosis UI in step 410, the failure diagnosis UI 150 sends the diagnosis request message to the failure diagnosis framework 140 based on the information entered by the user in step S406.

Accordingly, in step S412, the failure diagnosis framework 140 may diagnose the cause of the failure, i.e., may detect error information identical or similar to the error code or the error phrase by comparing the error code or the error phrase included in the received error message or the failure detection information with a preset database.

The failure diagnosis framework 140 sends the failure diagnosis result information to the failure diagnosis UI 150, and then the failure diagnosis result information is displayed on the display unit inside the failure diagnosis UI 150 in step S414. Alternatively, when the failure diagnosis UI 150 detects the user terminal device connected to user 160, the failure diagnosis result information is sent to the user terminal device, and therefore the user 160 may check the results of the failure diagnosis.

This enables every failure occurring in a home or a building to be detected automatically or by the user, and also enables the failure diagnosis to be requested, thereby achieving the advantage of rapidly handling the failure.

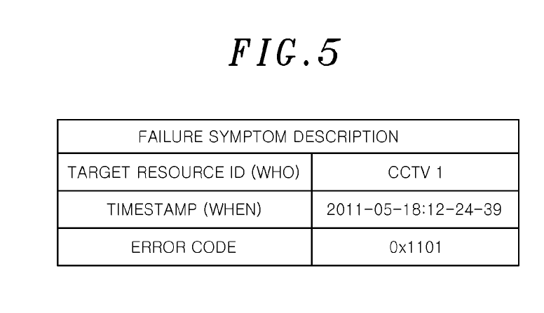

FIG. 5 is a diagram showing failure occurrence information in accordance with the embodiment of the present invention.

Referring to FIG. 5, when the failure has been detected and then the failure diagnosis is requested, the failure diagnosis UI 150 and the home/building integrated resource manager 130 may request the failure diagnosis by creating failure occurrence information indicative of symptoms of the failure and then sending the corresponding information to the failure diagnosis framework 140.

That is, a resource where the failure occurred (target resource ID (who)), the time at which a failure occurred (timestamp (when)), and the type of the failure (error code) may be entered in the failure occurrence information. The failure diagnosis UI 150 may receive the corresponding information from the user, and the integrated resource manager 130 may create the failure occurrence information based on monitoring information sent from the resource information collector 120 or the individual resource.

For example, when CCTV1 sends an error message including the error code 0x1101 to the resource information collector 120 at 24 minutes and 39 seconds after 12 o'clock on May 18, 2011, the resource information collector 120 may send the monitoring information received from CCTV1 to the home/building integrated resource manager 130. Accordingly, the home/building integrated resource manager 130 may create the failure occurrence information based on the corresponding monitoring information.

As described above, the method and apparatus for detecting the failures and requesting the failure diagnoses in accordance with the embodiments of the present invention are capable of rapidly and automatically discovering a variety of failures in a home/building network environment and requesting the failure diagnoses. When the home/building integrated resource manager receives the error message from a resource object on a home/building network and then detects the failure, the home/building integrated resource manager automatically requests the failure diagnosis. On the other hand, when there is no error message and the user has discovered the failure, the user may enter failure detection information and then request the failure diagnosis using the user interface (UI).

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for detecting failures and requesting failure diagnoses, comprising:
receiving monitoring information from an resource object;
if an error message is included in the received monitoring information, determining that a failure has been detected in the resource object to send a failure diagnosis request message to a failure diagnosis framework; and
receiving failure diagnosis result information from the failure diagnosis framework.

2. The method of claim 1, further comprises, if the failure has been detected in the resource object, sending the monitoring information including an error message o receive same.

3. The method of claim 1, wherein said receiving failure diagnosis result information comprises, at the failure diagnosis framework, comparing an error code included in the error message with a preset database, including error information matching the error code in the failure diagnosis result information, and sending the failure diagnosis result information.

4. The method of claim 3, wherein the error message comprises at least one of an equipment name of the resource object, error occurrence time, and the error code.

5. A method for detecting failures and requesting failure diagnoses, comprising:
if an error message is included in monitoring information received from an integrated resource manager, determining that a failure has been detected in a resource object to send a failure diagnosis request message to a failure diagnosis framework;
making a failure diagnosis based on the error message at the failure diagnosis framework, to send failure diagnosis result information to the integrated resource manager;
sending the failure diagnosis result information to a failure diagnosis user interface at the integrated resource manager; and
outputting the failure diagnosis result information at the failure diagnosis user interface.

6. The method of claim 5, wherein said sending failure diagnosis result information to the integrated resource manager comprises, at the failure diagnosis framework, comparing an error code included in the error message with a preset database, including error information matching the error code in the failure diagnosis result information, and sending the failure diagnosis result information.

7. The method of claim 5, wherein said outputting the failure diagnosis result information comprises displaying the failure diagnosis result information on a display unit inside the failure diagnosis user interface.

8. The method of claim 5, wherein said outputting the failure diagnosis result information comprises sending the failure diagnosis result information to a previously connected user terminal device.

9. The method of claim 5, further comprising:
periodically creating monitoring information at a resource object;
if a failure has occurred in the resource object, creating the error message including an error code; and
sending the monitoring information including the error message to the integrated resource manager.

10. The method of claim 5, further comprising:
receiving failure detection information of the resource object and a failure diagnosis request command at the failure diagnosis user interface; and
sending the failure diagnosis request message including the failure detection information to the integrated resource manager.

11. An apparatus for detecting failures and requesting failure diagnoses, comprising:
a resource object configured to, if a failure has occurred, second monitoring information including an error message; and
an integrated resource manager configured to, if an error message is included in monitoring information received from the resource object, determine that a failure has occurred in the resource object, send a failure diagnosis request message to a failure diagnosis framework, and receive failure diagnosis result information from the failure diagnosis framework.

12. The apparatus of claim 11, wherein the integrated resource manager receives the failure diagnosis result information that the failure diagnosis framework sends after comparing an error code included in the error message with a preset database and then including error information matching the error code in the failure diagnosis result information.

13. The apparatus of claim 12, wherein the error message comprises at least one of an equipment name of the resource object, error occurrence time, and the error code.

14. An apparatus for detecting failures and requesting failure diagnoses, comprising:
an integrated resource manager configured to, if an error message is included in received monitoring information, determine that a failure has been detected in a resource object, and send a failure diagnosis request message to a failure diagnosis framework;
a failure diagnosis framework configured to make a failure diagnosis based on the error message, and send failure diagnosis result information to the integrated resource manager; and
a failure diagnosis user interface (UI) configured to, when receiving failure detection information of the resource object, send the failure detection information to the integrated resource manager, and, when receiving the failure diagnosis result information from the integrated resource manager, output the failure diagnosis result information.

15. The apparatus of claim 14, wherein the failure diagnosis framework compares an error code included in the error message with a preset database, includes error information matching the error code in the failure diagnosis result information, and send the failure diagnosis result information to the integrated resource manager.

16. The apparatus of claim 14, wherein the failure diagnosis UI displays the failure diagnosis result information on a display unit inside the failure diagnosis user interface.

17. The apparatus of claim 14, wherein the failure diagnosis UI sends the failure diagnosis result information to a previously connected user terminal device.

18. The apparatus of claim 14, wherein the resource object:
periodically creates monitoring information;
if the failure has occurred, creates the error message including an error code; and
sends the monitoring information including the error message to the integrated resource manager.

19. The apparatus of claim 14, further comprising a resource information collector configured to receive and collect monitoring information from at least one resource object, and, if a preset time span has elapsed or if a preset number of pieces of monitoring information have been collected, send the collected monitoring information to the integrated resource manager.

20. The apparatus of claim 14, wherein the failure detection information comprises at least one of an equipment name of the resource object, error occurrence time, the error code, and an error phrase.
